(19) United States
(12) Patent Application Publication
(10) Pub. No.: US 2010/0332214 A1
(43) Pub. Date: Dec. 30, 2010

(54) SYSTEM AND METHOD FOR NETWORK TRANSMISION OF SUBTITLES

(76) Inventors: Shahar SHPALTER, Herzelia (IL); Ori Shechter, Tel-Aviv (IL)

Correspondence Address: Pearl Cohen Zedek Latzer, LLP, 1500 Broadway, 12th Floor, New York, NY, 10036, US

(21) Appl. No.: 12/494,753

(22) Filed: Jun. 30, 2009

(51) Int. Cl. G06F 17/28; G06K 9/34

(52) U.S. Cl. 704/2; 382/176; 704/E17.001

(57) ABSTRACT

A system and method for storing, associating and displaying transcriptions and translations of text presented in video segments.

### FIELD OF THE INVENTION

The present invention relates generally to transmission over a network of subtitles for video files.

### BACKGROUND OF THE INVENTION

The growth of network transmission of video clips has increased the need for multi-language subtitles that may also be transmitted over a network. Transmission of subtitles in numerous languages is cumbersome and intrusive to viewing of the video. Storage of numerous versions of a video file, where each includes a different subtitle language is expensive.

### SUMMARY OF THE INVENTION

A method of the invention may include dividing text of a video into a series of semantic segments, dividing a display of text of a segment of the series of segments into a series of subtitle display lines if a number of characters in a transcribed text of the segment exceeds a number of characters that are suitable for display on a single line, and adjusting a duration of a display of the transcribed text of the segment if a number of words in the transcribed text of the segment exceeds a time-to-word ratio or other predefined number of words that are suitable for reading in a given period.

In some embodiments, the dividing may include dividing the display of text of the video or semantic segment into a series of lines if a number of characters in a transcribed text of the segment exceeds a number of characters suitable for a single line of display of the transcribed text.

A method of the invention may include calculating a quantity of text presented in a video segment, calculating a quantity of transcribed text suitable for display during the video segment; adjusting the quantity of text presented in the video segment to the amount of text that is suitable for display during the video segment; and displaying the adjusted amount of text on a display of the video segment at a time or period during which the text of the video segment is presented.

In some embodiments, the calculating may include comparing a number of characters in the text to a maximum number of characters suitable for display during the video segment.

In some embodiments, the calculating may include comparing a number of words in the text to a maximum number of words suitable for display during the video segment or in a duration of the time of the video segment.

In some embodiments, a method may include displaying a transcribing of a text presented in a video segment; accepting a ranking for the displayed transcribing, displaying a second transcribing of the text presented in the video segment and accepting a ranking of such second transcribing; and selecting the first transcribing for further displays if the ranking of the first transcribing is greater than the ranking of the second transcribing or some pre-defined value. In some embodiments, the second transcribing may be accepted from a remote user, and may be associated with the video segment.

In some embodiments, the rankings may be associated with a transcribing correction of a user so that a user's transcribing correction may be stored or displayed if the user's ranking as submitted by other users exceeds a pre-defined number.

Some embodiments may include recording a word in a first translation; and associating the recorded word in the first translation with a word of an original language of the text. Some embodiments may include translating, in a second video segment, the stored word from the original language of the text with the stored word in the first translation.

In some embodiments, a method may include transcribing textual content of a video file into a database file; identifying a first segment of textual content in the text database file with a point on a timeline of the video file, and identifying a second entry of textual content in the text database file with a second timeline point on the video file; displaying the first entry of the transcribed textual content over a display of the video file concurrent with the first timeline point of the video file, and displaying the second entry of the transcribed textual content over a display of the video file concurrent with the second timeline point of the video file.

In some embodiments, the first entry includes a word of textual content, and chronological data includes a time during the video file wherein the word is heard.

In some embodiments, a method may include associating an address of the text database file with an address of the video file.

In some embodiments, a method may include retrieving the text database file or a portion of it from a first sever and retrieving the video file from a second server.

In some embodiments, the associating may include calling a URL that designates a domain of the video file, and including in the called URL a parameter that designates a timeline point.

In some embodiments, a method may include selecting a language of the transcribed textual content to be displayed over the display of the video content, and the displaying includes displaying the transcribed textual content in the selected language.

In some embodiments, a method may include synchronizing a subtitle of a video file by associating a text entry of a subtitle with chronological data of a video where the chronological data corresponds to a presenting time of the subtitle in the video; accepting a request for a mark up file, that includes the text entry and the associated chronological data; accepting a request for the video file; and calling the text entry from the mark up file to appear over a display of the video file upon reaching the associated chronological data of the video file.

In some embodiments, a method may include transcribing textual content of the video file into the mark up file.

In some embodiments, accepting the request for the mark up file includes accepting a request to provide the mark up file from a first server; and accepting the request for the video file includes accepting the request to provide the video file from a second server. In some embodiments, a method may include associating the mark up file with the video file, and generating a call for the mark up file upon a call for the video file, for example by attaching a URL for the mark up file as a parameter to a URL for the video file.

In some embodiments, a method may include accepting a request for a language from among different languages in the text file, and calling the text entry from the mark up file includes calling the text entry in the requested language.

In some embodiments, a method may include transmitting over a network from a first server a first file containing video content; and transmitting over the network from a second server a second file containing transcribed textual content of the video content, where the textual content is synchronized for display to a remote user on the network with a display of the video content to the remote user.

In some embodiments, transmitting transcribed textual content over the network from the second server includes transmitting a mark up file containing transcribed textual content of the video content.

In some embodiments, a method may include associating a text entry in a text file with time data of a video file; delivering the text file to a recipient of a video file; and displaying the text entry upon reaching a time of a designated time data in the video file.

In some embodiments, a method may include allocating text for display on a video, determining if a quantity of text associated with a period of the video exceeds a pre-defined limit between a time-in of the text and a timeout of the text; and extending the period between the time-in and the timeout.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a simplified diagram of a system in accordance with an embodiment of the invention;

FIGS. 2A and 2B show a structure of a mark up file in accordance with an embodiment of the invention;

FIG. 3 is a flow diagram of a method in accordance with an embodiment of the invention;

FIG. 4 is a flow diagram of a method in accordance with an embodiment of the invention;

FIG. 5 is a flow diagram of a method in accordance with an embodiment of the invention;

FIG. 6 is a flow diagram of a method in accordance with an embodiment of the invention;

FIG. 7 is a flow diagram of a method in accordance with an embodiment of the invention;

FIG. 8 is a flow diagram of a method in accordance with an embodiment of the invention;

FIG. 9 is a flow diagram of a method in accordance with an embodiment of the invention; and

FIG. 10 is a flow diagram of a method in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the embodiments of the invention.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating”, “comparing” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution result in a method of an embodiment of the invention. In some embodiments, one or more processors may perform one or more of the processes described herein, or more that one of such processes may be performed by a single processor. In some embodiments, one or more of the methods or systems described in this paper may store data for later presentation, may associate data with other data, may combine data with other designated data or may replace, add to or modify certain written or spoken words with other written or spoken words.

In some embodiments a network may, in addition to its usual definition, refer to a local area network wherein a limited number of user computers, terminals or hand-held communication devices may request and receive content files such as video, audio or text files from one or more computers such as a server or another computer which may store and/or transmit such files. In some embodiments, a network may include a wide area network such as for example the Internet, a cable TV, cellular telephone network or other networks. In some embodiments a server may, in addition to its usual definition, refer to an electronic device suitable to retrieve or access a stored file, and transmit such file or content from such file to one or more computers on the network in response to a request for such transmission. In some embodiments a video file may, in addition to its usual definition, include electronically stored image data that may include still or moving images, or that may include only audio data, such as for example a recoding of song or speech. In some embodiments, the term transcribed textual content may, in addition to its usual meaning, include a written text of some or all of the spoken, heard or displayed words on the video or image file. In some embodiments a transcribing of text may include a translation of such text.

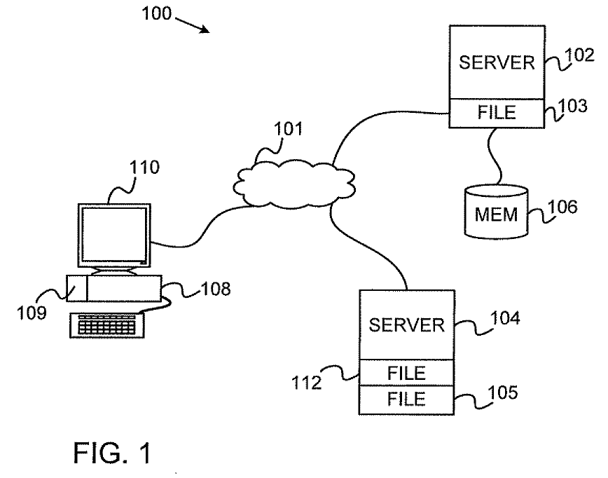

Reference is made to FIG. 1, a simplified diagram of components of a system in accordance with an embodiment of the invention. In some embodiments, a system 100 may include a network 101 that has connected to it a series of servers 102 and 104, a memory 106, such as an electronic mass data storage data base or other structured memory, that is accessible to one or more of the servers, a remote terminal computer 108 having a processor 109, such as for example a user's computer and a display 110. Some of components included in system 100 may be combined into fewer or greater number of components.

In operation, server 102 may store a file 103 that includes a video segment, such as a movie, video clip or other series of images. Server 104 may store a file 105, such as for example a mark-up file such as an XML file, that includes text transcribed from some or all of the spoken or heard speech on file 103. In some embodiments, server 104 may store a file 105 that may include text stored other than in an XML or mark-up format, and such text may be loaded into an XML or mark-up format at a later stage. Computer 108 may request that server 102 transmit to it the file 103 containing the video segment. Such request or a different or related request may be issued to or may generate another request to be issued to server 104 to transmit file 105 that includes transcribed text of the spoken, visual or heard speech of file 103. The request may specify a language of the subtitles or text that are to be transmitted from file 105 or that are to appear on display 110. The transcribed textual content may be synchronized for display so that the text or subtitles from file 105 corresponds in time to the spoken words in file 103 as they appear on display 110. Requests for and transmission of more than two files are possible, and transmissions may include a series of streamed data from one or more of such files.

In some embodiments, text that is spoken or that otherwise appears in file 103 may be transcribed into for example a data base file 105 or mark-up file such as for example an XML file. Other structured file formats may be used, and loading text from a data base file 105 into a mark-up file may be done at later stages such as for example once data from file 105 has reached computer 108. For example, in some embodiments the database file 105 (or part of it) may be formatted into mark-up by server 104, upon a client request. In some embodiments such transcribing may be performed by for example a speech-to-text transcribing engine, or such text may be typed or otherwise transcribed manually.

Transcribing functions may be performed by packages such as Microsoft™ Speech to Text or Sphinx open source speech to text. File 105 may be stored in and accessed from a server 104 that may be remote from server 102. In some embodiments, text that is made available from a transcription may be viewed, edited, corrected and reloaded into data base file 105. In some embodiments, a remote user may perform such correction and reloading.

In some embodiments, an initial transcribing may be generated automatically, and a person may review and edit or correct the automated transcribing, and reload the correction into the relevant entry in file 105. In some embodiments, a remote user, such as a viewer of the video in file 103, may receive access to file 105, and may be allowed to correct a transcribing entry. Upon authorization, the user may upload a correction or a new transcription into file 105, and such edit, correction or new transcribing may be made available to subsequent users or viewers. Such authorization may allow community participation in transcribing or editing of transcribed series of videos.

In some embodiments, text or a text entry that may appear or be heard in a portion of the video in file 103 may be transcribed into a text entry in the data base or mark up file 105, such as for example a mark-up entry. Another entry in file 105 may store chronological data about or associated with the text entry. Such chronological data may for example follow a time line of the video clip in file 105 from which the text entry was transcribed, and may track for example a time elapsed since the start of the video clip, such that the period during which the speech is heard on the video in file 103 may be recorded in file 105. In some embodiments, a start time or time-in may be recorded to indicate the beginning of the period in the video file 103 when the speech was heard, and an end time or timeout point may be recorded as the end of the period in the video file 103 when the speech was heard. The time-in and timeout times may be stored as separate entries in file 105 and associated with the relevant text entry that is heard or presented during such time.

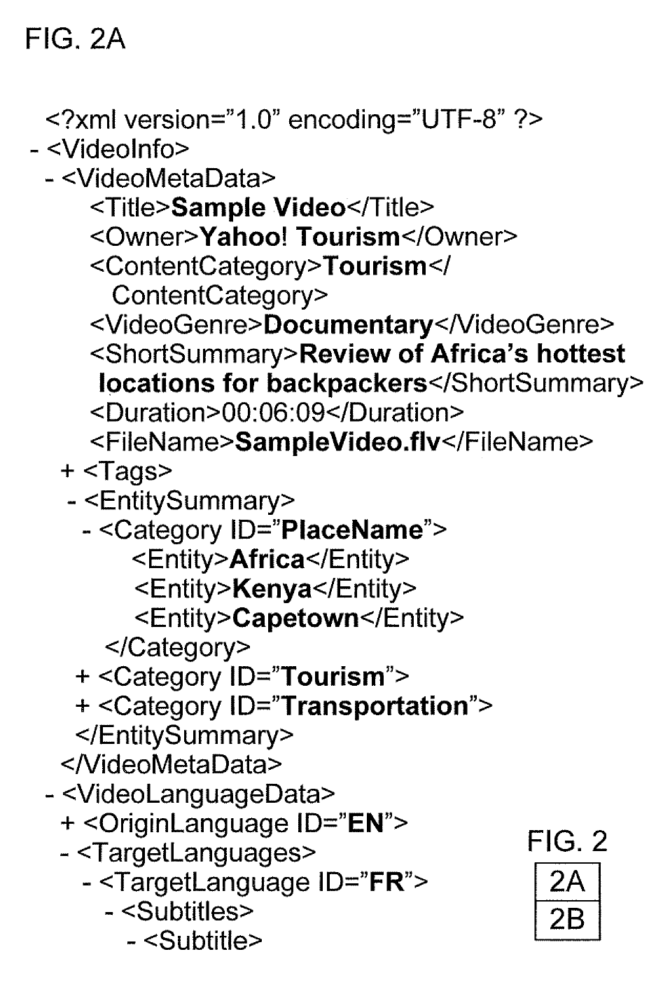

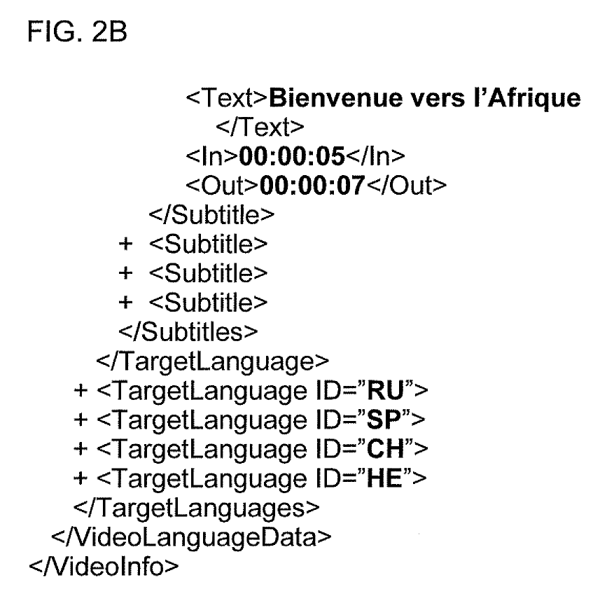

The transcribed text entry may be translated into one or more languages that may also be stored as separate entries in file 105 or in a related file. Each translation of a text entry may be associated in file 105 with the original language text entry and with other text entries of the different or translated languages so that the various translations of one or more text entries are indexed by language, and are associated by the chronological or other identification data that is stored for each text entry. For example, a first text entry in an original language in file 105 may be associated with a subsequent or second entry in file 105 in the same original language. The first entry in the original language may also be associated with a first entry in a first translated language and with a first entry in a second translated language, and all of such entries may be stored in one or more files. The first entry in the first translation language may be associated with a second entry in that same language, and the first entry in the second language may be associated with a second entry in the second language, such that an entry may have multi-dimensional associations with subsequent text in its own language as well as with its own translation entries in other languages. A sample of a mark up file that may perform some of these association functions in attached as FIGS. 2A and 2B.

In a simplified form, a text entry may be associated with a time-in point or with other identification data, such as a point on a timeline of a video. The text entry may be called when the time-in point is equal to the elapsed point on the video timeline. The text entry may disappear when the timeout point is equal to the elapsed point on the video timeline. In some embodiments, a unique identification number may be assigned to one or more entries, and the associations between and among entries may be created on the basis of such identification numbers. For example, in some embodiments, entries that include translations of the same text may be associated on the basis of similarities of their identification numbers. One or more of such entries may also be associated with the segment of the video clip that corresponds to the time on the video clip that corresponds to the spoken text. Other ways of associating text entries among themselves and with time-in and timeout points of video segments are possible.

In some embodiments, a translation of a text entry may be generated by a person or by an automated translation engine, such as those as may be available from SYSTRAN, Google translator, Amikai or others. In some embodiments, an initial translation may be generated automatically, and a person may review and edit or correct the automated translation, and reload the correction into the relevant entry in file 105. In some embodiments, a remote user, such as a viewer of the video in file 103, may receive access to file 105, and may request to correct a translation entry or request to add a language to the languages included in file 105. Upon authorization, the user may upload a correction or a whole new translation into file 105, and such edit, correction or new translation may be made available to subsequent users or viewers. Such authorization may allow community participation in a translation or editing of translation of a series of videos.

In some embodiments, a remote user may be invited to comment on or correct a transcribing or translation of a video clip, segment or word, and to submit the correction to server 104. In some embodiments a remote user may be invited to rate or rank a transcribing or translation of a video clip, segment or even word that the remote user viewed. A collection of rankings of a transcribing or translation of a segment or word may be made, and a transcribing or translation having for example a highest ranking from among users who viewed the transcribing or translation and submitted a ranking may be used to enhance a statistical corpus of a transcribing or translation engine, thus improving its performance. In some embodiments, a processor or memory may store rankings that may have been collected about one or more translations that are submitted by a particular user or translator, such that the translator is ranked as being a reliable or accurate translator. Categorization of a user as a reliable or accurate translator may be used as signal or authorization to processor to accept future translations that are submitted by the user.

In some embodiments, a user may call or request that a video file 103 be provided from server 102 over a network to his remote computer or display. A parameter, such as an HTML parameter, may be added to or generated by such request, to also request that file 105 be provided to the user from server 104. As a result, both file 103 and file 105 may be provided to a remote user who requests to receive a video. In some embodiments a data base that includes text of video may be searched by for example textual search term, time-code, semantic category, or other search modes, and the search request may be passed from a client application as one or more parameters to server 104. The search may return a specific time on a video clip or even a portion of the video clip wherein a particular word or category of words may be used or heard. For example, in some embodiments, a search for a word ‘vacation’ may return the term Hilton™ or other pre-defined terms that match a searched category.

In some embodiments, a user may be prompted to select a language from among the translations of the video in file 103 that are available in file 105. Upon such selection, processor 109 in computer 108 may draw from the text entries from file 105 those entries that are in the selected language.

In some embodiments, an initiation of the video in file 103 may also initiate file 105 to display text entries that correspond to the spoken or visual text in the video. For example, file 105 may track the chronology or time stamp of file 103 as such time stamp advances upon the viewer's viewing of the video. A text entry may be called from file 105 when the time stamp of the video reaches for example a time-in point that is associated with the text entry, and such text entry may displayed at for example the bottom of the screen wherein the video images appear. The displayed text may disappear or be removed from the display when the timeout point on the video chronology is reached. Other triggers for the appearance and disappearance of text may be used.

In some embodiments, a series of text entries for one or more of the languages into which the text of a video are translated may be shown in synchronized time with the appearance of the video to the user, so that the user may view the translation in subtitles that match the timing of the spoken or viewed text in the video file.

In some embodiments, a search engine such as for example Google or Cuil may be applied to the text entries in file 105, and a user may search file 105 for particular words or phrases that appear in one or more text entries in such file. In some embodiments, file 103 may be indexed by a found word or phrase in a text entry, so that the video of file 103 may be set to the time stamp or chronological data of a found word or phrase that was searched. This may allow a user to find and access a point in a video of file 103, by searching for a word in a text entry of file 105. For example, a user may search file 105 for a phrase ‘what's it gonna be, huh, punk’. Processor 109 or a processor connected with server 102 or server 104 may find that file 105 includes two entries that include such phrase, and may set file 103 to show user the segments of the video that include such text. In some embodiments, a user may search more than one text file 105 to find all or some of the times that a particular phrase was used in any of the videos whose text has been included in an accessible data base or mark-up file.

In some embodiments, a search function may be used to intersperse messages such as advertisements in a video or in a banner that may be displayed with a video. For example, if a text in file 105 uses words or phrases relating to cold weather, a banner may be inserted for a soup advertisement. If text refers to a particular music style or band, a banner may appear with a message relating to such music style or band. In some examples, such messages may be stored in one or more designated message files 112 on server 104 or on another server. Message files 112 may be called automatically from file 105 in advance of a text entry that relates to the particular message so that message file 112 arrives at display 110 to correspond with the period around the time-in and time out period where the text entry or relevant section of the video in file 103 appears.

In some embodiments, a user may search a series of text files 105 that correspond to a series of video files 103 for a particular phrase or word, and may collect a series of video clips that use the relevant words, phrases or series of words or phrases. A user may designate constraints for the text files 105 that are to be searched and may collect only desired clips that use the relevant words. For example, a user may have access to a series of video files 103 that include speeches made by presidents. A user may search the text files 105 associated with such video files 103 for a series of words, such as “Would you go out with me tonight”. Processor 109 may request to find each of such words in the various text files, and may collect the portions of the video files 103 wherein such words are found. Processor 109 may request to assemble a first clip showing Ronald Reagan saying the work ‘would’, a second clip showing George Bush saying the work ‘you’, a third clip showing Bill Clinton saying the work ‘go out’, a fourth clip showing George W. Bush saying the words ‘with me tonight’. Processor 109 or a processor connected with server 102 or server 104 may request to arrange the clips together into a combined video clip. In some embodiments, the search may be made of one or more translations of the text entries or of the original language, so that a word can be searched in a translation of the original language. Other categories of videos may be used such as from movies, sports figures etc. In some embodiments, one or more of the actions performed by processor 109 at computer 108, may also or alternatively be performed by a processor at server 102 or server 104.

In some embodiments, a set of results of a search on a series of text files 105 may include URL's of the videos that include the search term, and time-in parameters or other identification numbers associated with video wherein the term is found. Such URL may generate a call for the video file 103 as well as a call for the particular entry in file 105 that includes the search term. In some embodiments, the video and text entry will be displayed to the user from the point of time which was included in the parameter as was returned by the search.

In some embodiments, a word such as a first word that is presented or heard in a video and that is loaded into a mark-up file may be associated with one or more words that are presented contiguous with such first word in file 105, or within a brief time period of such first word. For example, if the phrase ‘grin and bear it’ is presented in a video, the word ‘bear’ may be associated with the word ‘grin’ as being contiguous or proximate. A translation of the phrase ‘grin and bear it’ in a particular language may also be stored in a database or mark up file that is associated with the original presented text. The association of the original and the translated phrase may be added to a data base of a translation engine, so that future appearances of a phrase that uses the words ‘grin’ and/or ‘bear’ are translated in accordance with the stored translation. In some embodiments, users may be invited to submit rankings about the translation of particular words or phrases, and the translation engine may be updated with the translation of a phrase that has for example the highest ranking. Translations with high rankings may be used in subsequent translation efforts.

Adjustments to the rate or method of display of subtitles may be appropriate to accommodate excessive speed or volume of spoken text material in a given video segment. For example, if a brief video segment includes more spoken text than can be fit into a single subtitling line, the single line may be broken into two lines that may be concurrently displayed on the screen. In some embodiments, a total number of characters or words that may be inserted onto one subtitle line may be predefined based on the constraints of for example font size, character spacing and other variables that may be dictated by the language or by other factors. In cases where the volume of the transcribed text exceeds the volume of words or characters that can be shown on one or two lines, the excess words or characters may be spilled over onto a second or even third subtitle line that may be displayed concurrently.

In another example, the volume of words or text that is spoken in the period between a time-in and a time-out may exceed the time characters or words that can be displayed or read by a reasonable viewer in such period. In some embodiments, the relevant period may be extended by adjusting one or both of the time-in or timeout points, and the excess text may be pushed over into a subsequent line that may be displayed in a next period of video. For example, a video segment of for example three seconds may include an amount of spoken text that generates an amount of transcribed text that is more than a user is able to read during such three seconds. In some embodiments, the transcribed text may be broken into a series of for example four subtitle lines, and a first two of such four lines may be displayed beginning slightly before the words are actually spoken in the video segment, and the display of the second two of such four lines may continue into a period slightly after the three second segment wherein such words are spoken. Other periods and lines of text are possible.

In some embodiments, a time-in point may be advanced so that transcribed text appears slightly before the words are actually heard or spoken on the video, and so that all of the subtitled text is given an appropriate period to appear and be read on the display. Similarly, a time-out point may be delayed to add more time for the transcribed words or subtitled lines to appear on the display. In some embodiments, the adjustment in time-in or timeout points may be of a fixed period, such as for example 0.5 seconds. Alternatively, an adjustment of a beginning and end point of a display of text may be made in variable increments to accommodate the amount of text to be displayed in the particular period. For example, a first adjustment may be made to, for example, a time-out point of displayed text and a calculation may be made of the number of words that are to be shown on the subtitle lines during the adjusted period. If the adjusted period is still not long enough to accommodate the number of words or subtitle lines required for the spoken text during the relevant period, the time-in point may also be adjusted by the pre-defined period of, for example, 0.5 seconds. Alternatively, an adjustment of a beginning point of a display of text may be made in variable increments.

In some embodiments, a word-to-time ratio of two words per second may be used to calculate an amount of text that may be displayed in a period, although other ratios are possible. For example, a number of words that are included in an entry or during a period of video may be calculated and divided by two to derive the number of seconds needed for the display of the words. If the time is insufficient to display the text an adjustment may be made to one or both of the time-in period or the time out period. Adjustments may stretch the period during which a text line appears until the time-in point of the next segment. In some embodiments, an amount of text or characters for a given video segment may vary among languages, such that adjustments to display lines for text may vary for the various translations. For example, font size, abbreviations, contractions, number of characters and other factors may influence a total number of words or characters that may be displayed in an available space in a particular language. In some embodiments, such data may be derived once a text has been transcribed from speech into text or at other times when text is changed or otherwise prepared for display. Other factors that may determine a number of lines or displays upon which to show text include the space required for displaying a subtitle and the space available on a screen for displaying a subtitle.

In some embodiments, text that is presented in a video file 103, may be divided into a series of semantic segments such as phrases or sentences. Such division may be performed by an automated engine such as openNLP engine. The divided segments may be used as the basis for calculating an amount of text that is to appear on a display of a subtitle or as a unit of text that is to then be divided into lines of subtitles or a series of displays of subtitles.

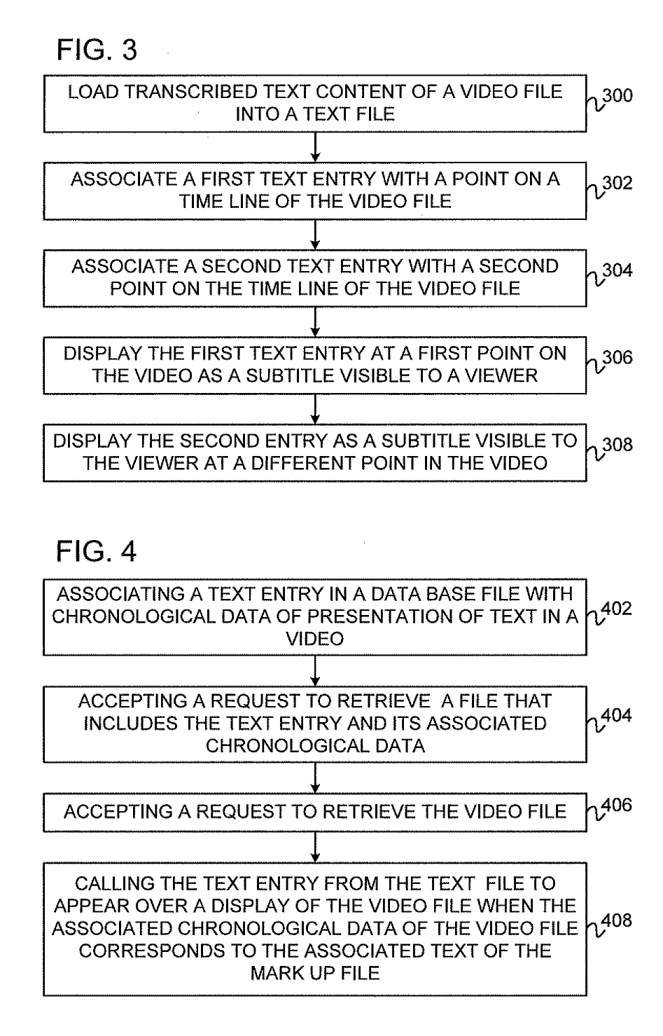

Reference is made to FIG. 3, a flow diagram of a method in accordance with an embodiment of the invention. In some embodiments, and as in block 300, the invention may include a method of transcribing textual content of a video file, and loading such textual content into a database file. The textual content may be spoken words or terms that are heard or seen in a video. The text may be transcribed or converted to text automatically, manually or in a combination of such processes. In block 302, the text entries may be loaded into a text file, such as a mark up file, and a loaded text line or word of such text may be associated with a point on a time line of the video file, or such line or word may be assigned a unique identifier. For example, if a transcribed word in the video is heard at minute 2, second 24.37, the word may be associated with such point on the video time line or with other chronological or identification data of the video file. Other words may likewise be associated with the respective times that they appear or are heard in the video. Other ways of associating words or text entries with points on the video are possible. In block 304, a second word or entry of textual content may be designated in the database file and may be associated with a point on the video file. In block 306, the text of a particular entry may be displayed over a display of said video file as a subtitle, closed caption or in some other manner that is visible to a viewer. In block 308, the word or text of another entry of transcribed textual content may be displayed at a different point in the video, such that the transcribed content is displayed relatively concurrent with the appearance or presentation of the spoken words from which such content was transcribed.

In some embodiments, the file that includes the textual content may be associated with an address of the file that includes the video, so that a request to retrieve the video file also retrieves the text file. For example, a video file may be stored at an address of a first server while the mark up or text file is stored at an address of a second server or in a second data base file on the first server. Upon a call of one of such files, the other file may also be retrieved. In some embodiments, the calls may be designated as a URL address, where a URL address of a second file is added as a parameter to the first call. In some embodiments, a point on the video time line that may have been used for associating a text entry with a point on the video may be designated as a domain and parameter used to call the video file, and the text entry and the particular point on the video file may be retrieved.

In some embodiments, a user may be prompted to select a language of the transcribed textual content from among several languages into which the content may have been translated, and such translated text entries may be displayed over the display of the video content.

Reference is made to FIG. 4, a flow chart of a method in accordance with an embodiment of the invention. Some embodiments may entail synchronizing a subtitle of a video file so that the subtitle is displayed concurrent with the words of text that are spoken or then being heard in the video. In block 402, a text entry in the mark up or data base file may be associated with chronological data of the video to correspond to a time when the text was presented in the video. In block 404, a processor may accept a request to retrieve a data base or mark up file that includes the text entry and its associated chronological data or other unique identification information. In block 406, a processor may accept a request to retrieve the video file. In block 408, a processor may call the text entry from the data base or mark up file to appear over a display of the video file when the associated chronological data of video file corresponds to the associated text of the mark up file.

In some embodiments, a method may include accepting a request to provide the mark up file from a first server and accepting a request to provide the video file from a second server. In some embodiments, an address of the mark up file may be associated with an address of the video file so that a call of one of the files generates a call of the other file. In some embodiments, an association between the two files may include attaching a URL of for example the mark up file as a parameter for a call of the URL of the video file.

In some embodiments, a processor may accept a request for a language from among the various translations in the data base or mark up file, and a call of the language from the data base or mark up file may include calling the translated text entry in the data base or mark up file.

In some embodiments, remote members of a community may participate in translating or editing one or more entries in the text file, and a remote memory may record an edit submitted by a user.

In some embodiments, a method may include accepting a request from a remote user to locate a text entry in a text file, and presenting to the remote user a portion of the video file that corresponds with the presenting time of the text entry, so that a user may search the data base or mark up file to locate a particular word or phrase. Once the word or phrase is located, the point on the video time line where such word or phrase appears is located in the video file, and a clip of the video file that includes the word or phrase is shown to the user.

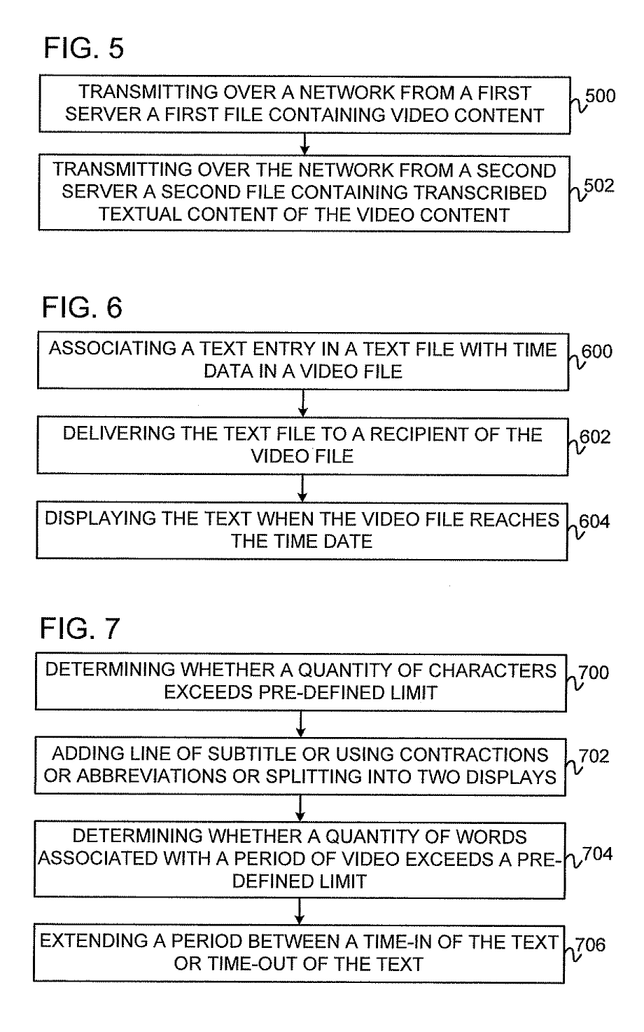

Reference is made to FIG. 5, a flow chart of a method in accordance with an embodiment of the invention. In block 500, there may be transmitted over a network from a first server a first file containing video content. In block 502, there may be transmitted over the network from a second server a second file containing transcribed textual content of the video content The textual content may be synchronized for display to the remote user with a display of the video content to the remote user.

Reference is made to FIG. 6, a flow chart of a method in accordance with an embodiment of the invention. In block 600, a text entry in a text or data base file may be associated with time data in a video file. In block 602, the text file may be delivered to a recipient of the video file. In block 604, an entry of the text or mark up or data base file may be displayed to a viewer of the video file when the video file reaches a time of the time data in the video file.

In some embodiments, the text entry in the data base or mark up file may be associated with both a time-in time and a timeout point corresponding to approximately a start and finish time of when the text is to be heard or appear in the video file, The text entry may be displayed during the period between the time-in and the timeout points of the video file.

In some embodiments, a first server may deliver the text or mark up file, and a second server may deliver the video file. In some embodiments, one of the video or mark up files may be delivered upon a request for the delivery of the other file, such that both files are delivered in response to the same request by a user. In some embodiments, a call for one file may be associated with a call for another of the files.

Reference is made to FIG. 7, a flow chart of a method for allocating text for display on a video in accordance with an embodiment of the invention. In some embodiments, and as is shown in block 700, a determination may be made of a maximum number of characters or words that may be suitable for display in a given space over a video segment that includes such words. A comparison may be made between such maximum number of characters or words that is suitable against the actual number of characters that are presented during such segment to determine whether the actual number exceeds the suitable or pre-defined number. In block 702, if the actual number exceeds the number that is suitable, then one or more the following may be performed: adding a line of subtitle text to the display, using contractions or abbreviations to reduce the number of words or letters, splitting the text into two displays, or taking other actions.

In block 704, a quantity of words associated with a period of video or with a segment of text may be calculated or determined, as to whether the quantity of words exceeds a pre-defined limit, such as for example a time-word ratio, or some other calculation of a quantity of text that a viewer can read or comprehend in a given period. In block 706, if the pre-defined limit is exceeded, the period between a time-in of the text, or when the text is to appear over a series of video images, and a timeout of the text, or when the text disappears from the video image, may be extended. In some embodiments, extending the period may include changing the time out to delay the point when the text disappears from the video image. In some embodiments, extending the period may include altering the time-in to a time on the video prior to the original time-in.

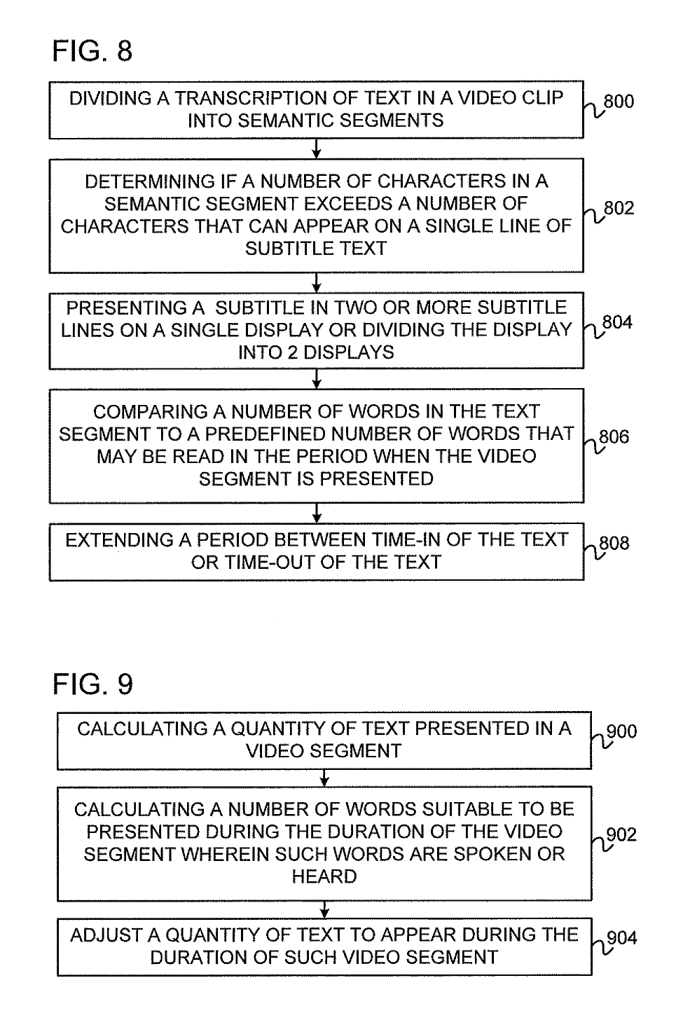

Reference is made to FIG. 8, a flow diagram of a method in accordance with an embodiment of the invention. In block 800, a method may include dividing a transcription of text that is presented in a video clip into one or more of a series of semantic segments, such as sentences, phrases or other words or groups of words that may be suitable for grouping together in a display of subtitles. In some embodiments, the division of transcribed text may be performed by a linguistic or acoustic engine, or may combine the results of both of the engines.

In block 802, a calculation may be performed as to the number of characters in a semantic segment, and a determination may be made as to whether such number of characters exceeds a number of characters that can appear on a single line of subtitle text. In some embodiments, such number of characters that are suitable for a single line may be predefined. In some embodiments, such number of characters that may be suitable for a single line of text may be variable depending on the font, abbreviations, contractions and other factors of the text presented or the available display.

In block 804, if a number of characters in the semantic segment exceeds a number of characters suitable for a single line of subtitle text, then the text may be presented in two or more subtitle lines on a single display, or may be displayed in two separate views or screen shots.

In block 806, a comparison may be made of the number of words in the text segment against a predefined number of words that may be read or understood by a viewer in the period of video wherein the segment is presented. In block 808, if the number of words in the presented text exceeds the comfortable word to time ratio of a typical viewer or some other predefined ratio, an adjustment may be made in the period of the display of the presented text. For example, a period of display of the presented text may be lengthened or extended until the word to time ratio is at or below a desired ratio. In some embodiments, adjusting a display time of presented text may include for example, altering or advancing a time-out point of the presented text so that the text disappears slightly after the relevant words are heard or spoken in the video segment. Similarly, a time-in time may be adjusted so that the presented text appears even before the words are spoken.

Reference is made to FIG. 9, a flow diagram of a method in accordance with an embodiment of the invention. In block 900, a calculation may be made of a quantity of text such as a number of characters or words that are presented in a video segment. In block 902, a calculation may be made as to the number of words that are suitable to be presented as transcribed text during the duration of the video segment wherein such words are spoken or heard. In block 904, the quantity of text that may be presented during a particular period of a video segment may be adjusted, such as reduced, so that the quantity of text presented is equal to or corresponds to the quantity that is suitable for such period. In block 904, the adjusted or reduced quantity of text may be displayed on a display of the video segment wherein in the text is presented or heard.

In some embodiments an adjustment may include a change to the time-in or time out of the display of the text or a division of the presented text on two or more displays.

In some embodiments, a calculation of a quantity of text may include a calculation of a number of characters that may be suitable to appear on a line, or a number of words that may be suitable to be read in a particular interval or period of a video segment.

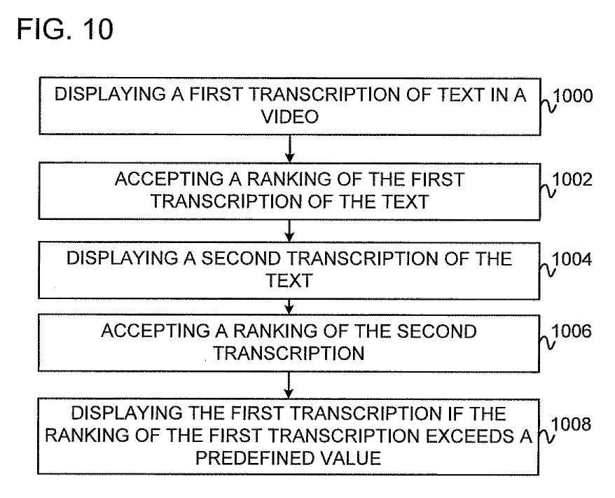

Reference is made to FIG. 10, a flow diagram of a method in accordance with an embodiment of the invention. In block 1000, a translation or transcription of text that may be spoken or beard in a video may be displayed. In block 1002, a second transcription or an adjustment to the transcription may be accepted, from a remote user, for the same or a different segment of the text presented in the video segment. In block 1004, more transcriptions or adjustments to the transcription may be accepted, from other remote users. In block 1006, a ranking of an accuracy of one or more transcriptions may be accepted by a memory from one or more users such as remote users. In block 1008, a processor may use the ranking to measure or rate the accuracy of some or all of transcriptions which were suggested. If a ranking of a translation or transcription is for example higher than a predefined number such as a ranking of all or some other transcriptions or translations or a minimum positive ranking rate such as 50% or some other figure, the subject transcription or translation may be accepted for the video segment and displayed. In some embodiments, the translation or transcription may be added to a memory such as a memory accessible to a transcription engine, to improve a future quality or performance of the engine by making the accurate transcription or translation available for future appearances of the transcribed text. In some embodiments the ranked translation or transcription may be used to determine the best transcription or translation out of different transcription or translation possibilities for the same heard text in an engine memory.

In some embodiments, a computer or processor may associate numerous rankings with the particular transcription that is displayed, so that a single transcription is the subject of several rankings. Such rankings may be averaged or otherwise analyzed to provide a single ranking for the translated or transcribed text.

In some embodiments, a transcription and a ranking of the transcription may be associated with a particular user or a provider of the transcription. A provider of the transcription may be ranked or evaluated in consideration of several rankings that were given by other users of one or more transcriptions that are submitted by the transcription provider.

In some embodiments, a word that may have been presented in an original transcription in a video segment may be associated with one or more transcriptions of the word that may be used in one or more transcriptions of some or all of the text in the video segment. The transcribed word may be added to a transcription engine's data base or data storage device, as a transcription for a spoken text or for increasing statistical rating for an existing transcription or in other ways that correlate to the engine's recognition mechanism, and may be used in future transcriptions, such as in an automated transcription engine. For example, a transcription engine may present the transcribed word as one from among several possibilities for a transcription of a word. In some embodiments, a processor may associate a series of spoken words with a particular transcription of such series of words.

In some embodiments, a word that may have been presented in an original language in a video segment may be associated with one or more translations of the word that may be used in one or more translations of some or all of the text in the video segment. The translated word may be added to a data base or data storage device, and may be used in a future translation, such as in an automated translation engine. The translated words may increase a translated word statistical rating or improve other mechanisms used by the translation engine. For example, a translation engine may present the translated word as one from among several possibilities for a translation of a word. In some embodiments, a processor may associate a series of words in a first language with a particular translation of such series of words.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

We claim:

1. A method comprising.
dividing text of a video into a plurality of semantic segments;
dividing a display of text of a segment of said plurality of segments into a plurality of lines if a number of characters in a transcribed text of said segment exceeds a first predefined number; and
adjusting a duration of a display of said transcribed text of said segment if a number of words in said transcribed text of said segment exceeds a predefined ratio.

2. The method as in claim 1, wherein said adjusting is selected from the group comprising adjusting a time-in of said display of said transcribed text, adjusting a time-out of said display of said transcribed text and dividing said display of said transcribed text into a plurality of displays of transcribed text.

3. The method as in claim 1, wherein said adjusting comprises adjusting said duration of said display of said text of said segment if a number of words in said transcribed text of said segment exceeds a number of words suitable to be read in a duration of said segment of said plurality of segments.

4. The method as in claim 1, wherein said dividing comprises, dividing said display of text of said segment of said plurality of segments into a plurality of lines if a number of characters in a transcribed text of said segment exceeds a number of characters suitable for a single line of display of said transcribed text.

5. A method comprising:
calculating a quantity of text presented in a video segment;
calculating a quantity of transcribed text suitable for display during said video segment;
adjusting said quantity of text presented in said video segment to said amount of said text suitable for display during said segment;
displaying said adjusted amount of text on a display of said video segment at a time of said video segment wherein said text is presented.

6. The method as in claim 5, wherein said adjusting is selected from the group consisting of adjusting a time-in of a display of said text, adjusting a time-out of said display of text, dividing said text into a plurality of text lines on said display, and dividing said text into a plurality of displays.

7. The method as in claim 5, wherein said calculating a quantity of transcribed text suitable for display comprises comparing a number of characters of said text to a maximum number of characters suitable for display during said video segment.

8. The method as in claim 5, wherein said calculating a quantity of transcribed text suitable for display comprises comparing a number of words in said text to a maximum number of words suitable for display during said video segment.

9. The method as in claim 8, wherein said comparing comprises comparing a number of words in said text to a maximum number of words suitable for display in a duration of said time of said video segment.

10. A method comprising:
displaying a first translation of a text presented in a video segment;
accepting a ranking of said first translation of said text;
displaying a second translation of said text presented in said video segment;
accepting a ranking of said second translation; and
displaying said first translation if said ranking of said first translation is greater than a pre-defined ranking.

11. The method as in claim 10, comprising accepting said second translation from a remote user; and storing said second translation in an association with said video segment.

12. The method as in claim 10, comprising associating said first ranking with a user; and displaying a translation of a second video segment from said user if said first ranking exceeds a pre-defined number.

13. The method as in claim 10, comprising recording a word in said first translation; and associating said word in said first translation with a word of an original language of said text.

14. The method as in claim 13, translating in a second video segment, said word of said original language of said text with said word in said first translation.
